(19) United States
(12) Patent Application Publication
(10) Pub. No.: US 2014/0298182 A1
(43) Pub. Date: Oct. 2, 2014

(54) CENTRALIZED ADMINISTRATION TOOL FOR OPERATING WITH EXISTING HOST SYSTEM HAVING NON-CENTRALIZED ADMINISTRATIVE FUNCTIONS

(71) Applicant: Infosys Limited, Bangalore (IN)

(72) Inventor: Sairam Sadanala, Oppicherla (IN)

(73) Assignee: Infosys Limited, Bangalore (IN)

(21) Appl. No.: 14/204,912

(22) Filed: Mar. 11, 2014

(30) Foreign Application Priority Data
Apr. 1, 2013 (IN) 1488/CHE/2013

(51) Int. Cl. H04L 12/24

(52) U.S. Cl. CPC H04L 41/22
USPC 715/736

(57) ABSTRACT

A system, medium and method of providing a centralized host manager module configured to manage a software-based host system having a plurality of independent host platforms is disclosed. A user interface is displayed to provide administrative tools for performing corresponding administrative functions on the plurality of host platforms. A selection is received via the user interface, wherein the selection is to perform a first administrative function on a first host platform. The first administrative function is associated with a generic command line program. Input data is received that is in conformance with the generic command line program. A finalized command line program is generated utilizing the generic command line program and first input data. The finalized command line program is sent to the identified host platform to cause the host platform to execute the finalized command line program.

### FIELD

The present disclosure relates to a centralized administration tool for operating with existing host system having non-centralized administrative functions.

### BACKGROUND

Host software systems exist which are designed to have multiple platforms which are decentralized and operate separate from one another. By virtue of the host system being designed to have these separate, independent platforms, a network administrator interfacing with the host system must repeat the same administrative tasks for each platform. One example of such a host system is the Informatica™ data integration software solution.

What is needed is a centralized administration tool for operating with existing host system having non-centralized administrative functions.

### SUMMARY

In an aspect, a method of providing a centralized host manager module configured to manage a software-based host system having a plurality of independent host platforms is disclosed. The method includes displaying a user interface of the host manager module on a network device. The user interface provides one or more administrative tools for performing corresponding administrative functions on the plurality of host platforms. The method includes receiving, at the host manager module, a first selection from the user via the user interface. The first selection is to perform a first administrative function on a first host platform, wherein the first administrative function is associated with a first generic command line program. The method includes receiving, at the host manager module, first input data from the user via the user interface. The first input data is in conformance with the first generic command line program. The method includes generating a first finalized command line program utilizing the first generic command line program and the first input data. The method includes sending the first finalized command line program from the host manager module to the first host platform. The first finalized command line program is configured to cause the first host platform to execute the first finalized command line program.

In an aspect, a processor readable medium having stored thereon instructions for providing a centralized host manager module configured to manage a software-based host system having a plurality of independent host platforms is disclosed. The medium comprises processor executable code which, when executed by at least one processor, causes the processor to display a user interface. The user interface provides one or more administrative tools for performing corresponding administrative functions on the plurality of host platforms. The medium causes the processor to receive a first selection from the user via the user interface, wherein the first selection is to perform a first administrative function on a first host platform. The first administrative function is associated with a first generic command line program. The medium causes the processor to receive first input data from the user via the user interface, wherein the first input data is in conformance with the first generic command line program. The medium causes the processor to generate a first finalized command line program utilizing the first generic command line program and the first input data. The medium causes the processor to send the first finalized command line program from the host manager module to the first host platform, wherein the first finalized command line program is configured to cause the first host platform to execute the first finalized command line program.

In an aspect, a computing device comprises a network interface capable of communicating with a host system having a plurality of independent host platforms. The computing device includes a memory having stored thereon code embodying machine executable programmable instructions. The computing device includes a processor configured to execute the stored programming instructions in the memory, which when executed by the processor, causes the processor to display a user interface. The user interface provides one or more administrative tools for performing corresponding administrative functions on the plurality of host platforms. The computing device is configured to receive a first selection from the user via the user interface. The first selection is to perform a first administrative function on a first host platform, wherein the first administrative function is associated with a first generic command line program. The computing device is configured to receive first input data from the user via the user interface, wherein the first input data is in conformance with the first generic command line program. The computing device is configured to generate a first finalized command line program utilizing the first generic command line program and the first input data. The computing device is configured to send the first finalized command line program from the host manager module to the first host platform, wherein the first finalized command line program is configured to cause the first host platform to execute the first finalized command line program.

In one or more of the above aspects, a second selection is received from the user via the user interface, wherein the second selection is to perform a second administrative function on a second host platform. The second administrative function is associated with a second generic command line program. Second input data is received from the user via the user interface, wherein the second input data is in conformance with the second generic command line program. A second finalized command line program is generated by utilizing the second generic command line program and the second input data. The second finalized command line program is then sent from the host manager module to the second host platform. The second finalized command line program is configured to cause the second host platform to execute the second finalized command line program.

In one or more of the above aspects, the first finalized command line program is configured to cause at least a portion of the input data to be stored in a database of the first host platform.

In one or more of the above aspects, the first input data for the first administrative function is stored in a storage. A second selection is received from the user via the user interface to perform a second administrative function, wherein the second administrative function is associated with a second generic command line program. At least a portion of the first input data is retrieved from the storage, wherein the retrieved first input data is applied to the second generic command line. A second finalized command line program utilizing the second generic command line program and the at least the portion of the first input data is then generated.

In one or more of the above aspects, login and password information from the user is received via the user interface. Credential information for the user is then retrieved using the received login and password information. Available administrative functions for each available host platform are then identified based on the credential information wherein the available administrative functions for each available host platform are displayed via the user interface.

In one or more of the above aspects, the first administrative function is associated with managing a relational connection in one or more host platforms.

### BRIEF DESCRIPTION OF THE DRAWINGS

FIG. 1A illustrates a diagram of an example system environment that utilizes a centralized administration tool which operates with a host system in accordance with an aspect of the present disclosure;

FIG. 1B illustrates a block diagram of a host system having decentralized platforms;

FIG. 2A illustrates a block diagram of a network device implementing a host manager in accordance with an aspect of the present disclosure;

FIG. 2B illustrates a block diagram of the components of the host manager in accordance with an aspect of the present disclosure; and

FIG. 3 illustrates a flow chart describing the host system managing capabilities of the present system in accordance with an aspect of the present disclosure.

### DETAILED DESCRIPTION

In general, the host manager 210 is a software implementation which interfaces and operates with a decentralized host system 112 provided by another software developer. In particular, the host manager 210 is configured to provide a centralized platform which allows an administrator to access a plurality of the host system's 112 independent platform solutions from a single, centralized user interface. Additionally, the host manager 210 utilizes a plurality of configurable platform manager modules 216 which are designed to provide generic platform executable instructions for an identified platform of the host system 112. The host manager 214 also utilizes a platform interface module 214 which utilizes input data provided by the administrator in association with the general command instruction to generate a finalized instruction that is sent to the appropriate platform of the host system 112 and/or its dedicated database(s).

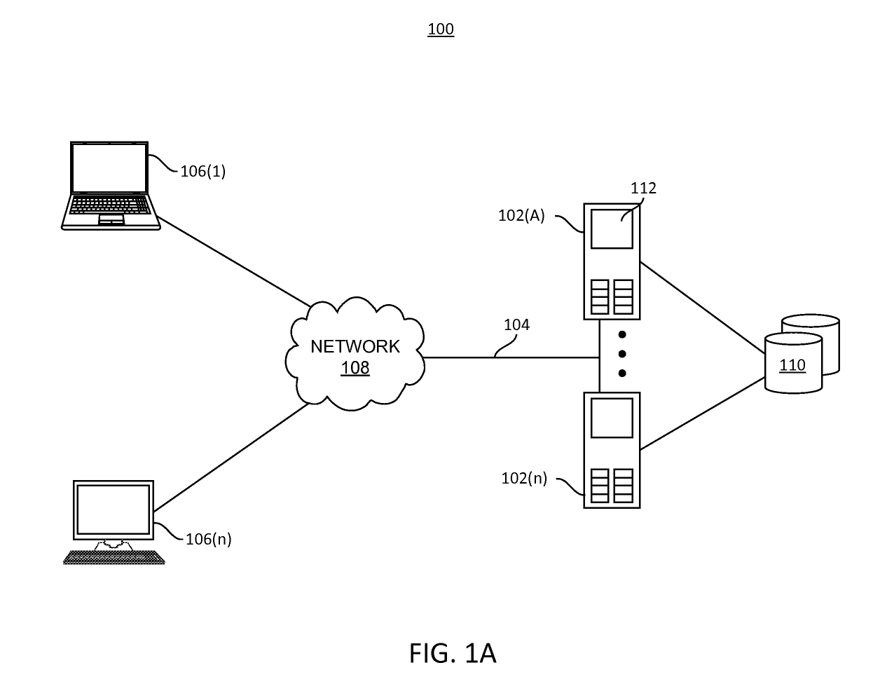

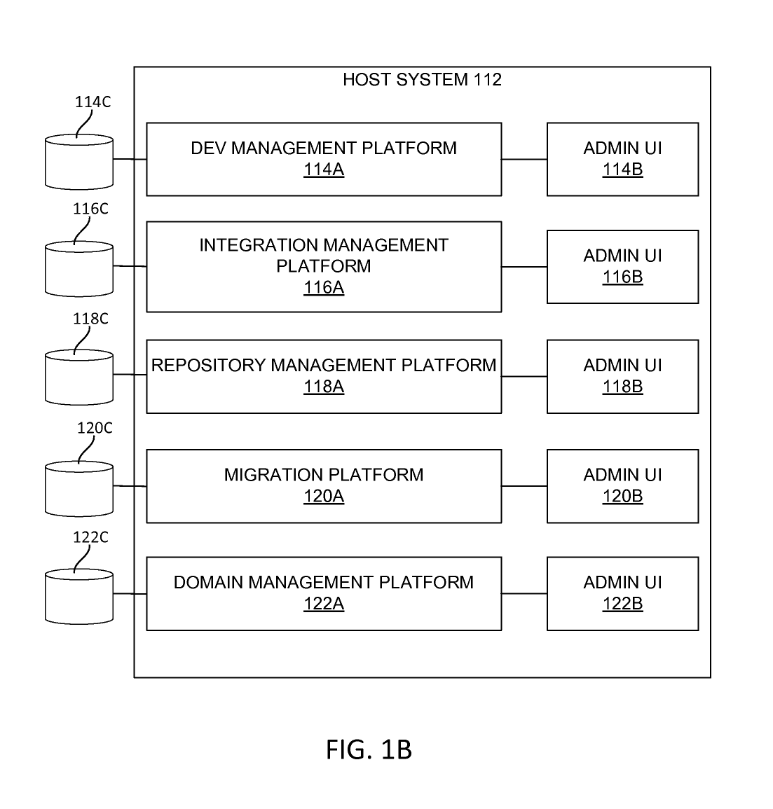

FIG. 1 illustrates a diagram of an example system environment that implements and executes a host system administration manager in accordance with an aspect of the present disclosure. In particular, the example system environment 100 includes a plurality of network enabled computing devices. It should be noted that the term “network devices” can be referred to as encompassing one or more client devices, one or more physical and/or virtual servers, cloud computing devices and/or other components in the system 100.

The servers 102(1)-102(n) include but are not limited to application servers, database servers, computation farms, data centers, virtual machines, cloud computing devices, mail or web servers and the like. The network system 100 includes one or more client devices 106(1)-106(n), although the environment 100 could include other numbers and types of devices in other arrangements. The servers 102(1)-102(n) are connected to a local area network (LAN) 104 as well as a wide area network 108. The client devices 106(1)-106(n) are connected to the wide area network 108.

The servers 102(1)-102(n) comprise one or more computing devices or machines capable of operating one or more Web-based and/or non Web-based applications that may be accessed by other network devices (e.g. client devices, other servers) via the network 108. In an aspect, the one or more servers 102(1)-102(n) operate a host system solution which has multiple decentralized platforms. One or more servers 102(1)-102(n) may be front end Web servers, application servers, and/or database servers. Such data includes, but is not limited to Web page(s), image(s) of physical objects, user account information, and any other objects and information. It should be noted that the servers 102(1)-102(n) may perform other tasks and provide other types of resources.

One or more servers 102 may comprise a cluster of a plurality of servers which are managed by a network traffic device such as a firewall, load balancer, web accelerator, gateway device, router, hub and the like. In an aspect, one or more servers 102(1)-102(n) may implement a version of Microsoft® IIS servers, RADIUS servers and/or Apache® servers, although other types of servers may be used and other types of applications may be available on servers 102(1)-102(n). It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as Web-based and/or non Web-based requests, receiving responses to requests and/or performing other tasks, in accordance with the novel processes described herein. Non-limiting and non-exhausting examples of such client devices 106(1)-106(n) include, but are not limited to, personal computers, mobile phones and/or smart phones, pagers, tablet devices, PDAs and the like. In an aspect, the client device 106 may be configured to run a Web browser or other software module that provides a user interface for human users to interact with and access a host managing module, as will be described in more detail below, via the browser and/or a locally stored mobile application.

Network 108 comprises a publicly accessible network, such as the Internet, which handles communication between the client devices 106(1)-106(n) and the servers 102(1)-102(n). However, it is contemplated that the network 108 may comprise other types of private and/or public networks. Communications between the client devices 106(1)-106(n) and the servers 102(1)-102(n) preferably take place over the network 108 according to network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate computing devices may act as links within and between LANs, WANs and other networks to enable messages and other data to be sent and received between computing devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications technologies.

As shown in FIG. 1A, the environment 100 may include one or more databases 110 coupled to the computing devices 102, 106 in which the databases 110 are configured to allow storage and access to data, files or otherwise information utilized or produced by the host system 112 and/or the host managing module 210. As shown in FIG. 1B, the various platforms 114-122 of the host system 112 may store, retrieve and otherwise access information in their dedicated databases 114C-122C. Databases are well known in the art, and details regarding databases 110 will not be described herein.

In accordance with the present disclosure, as shown in FIG. 1A, one or more servers 102(1)-102(n) operate a host software system 112 designed to have multiple platforms which operate separately from one another and are not configured to share information with one another. Accordingly, the host software system 112 has a decentralized platform architecture, wherein each platform may be designed to be a standalone platform solution which is utilized by a specific set of customers. By virtue of the host system 112 being designed to have these separate, independent platforms, a network administrator interfacing with the host system must separately log into (and out of) each platform to perform administrative tasks. For instance, an administrator performing a specific administrative task in one of the host system's 112 platforms will be required to repeat the same administrative task in another of the host system's 112 platforms. One example of such a host system 112 is the Informatica™ data integration software solution, although other decentralized host systems are contemplated.

FIG. 1B illustrates an example block diagram of a decentralized host system. In particular, the example host system 112 shown in FIG. 1B includes a plurality of separate, discreet host platforms, such as a developer management platform 114A having a dedicated administrator user interface (UI) 114B and one or more dedicated storage databases 114C, an integration management platform 116A having a dedicated administrator UI 116B and one or more dedicated storage databases 116C, a repository management platform 118A having a dedicated administrator UI 118B and one or more dedicated storage databases 118C, a migration platform 120A having a dedicated administrator UI 120B and one or more dedicated storage databases 120C, and a domain management platform 122A having a dedicated administrator UI 122B and one or more dedicated storage databases 122C. It should be noted that the platforms illustrated in FIG. 1B and described herein are exemplary and additional, fewer, and/or different platforms are contemplated to be part of the host system 112.

The host system 112 in FIG. 1B is configured such that each platform performs specific functions for specific customers using the host system 112. By virtue of each platform being independent from one another, each platform stores, retrieves and otherwise accesses one or more dedicated databases, wherein information added, deleted or modified in one platform's dedicated database is not shared with any of the other platforms' databases. Further, each platform has a dedicated administrator user interface (UI) which allows an administrator to access a specific platform via its dedicated UI. Accordingly, an administrator who accesses the dev management platform 114A, via the admin UI 114B, and adds a user to database 114C will then have to log out of the admin UI 114B, login to admin UI 116B and again add that user to the integration management platform 116A, which is then stored in database 116C.

Each platform's database(s) may store general and specific data that is utilized by its corresponding platform to perform operations. Such data stored may include login/password information, credential information, security and other policy information, administrator profile data, user profile data, customer profile data, and the like.

In an aspect, each of the platforms 114-122 of the host system 112 are designed to execute instructions in the form of command line programs that are generated by the administrator. In particular, the host system 112 utilizes a set of established generic command line programs that may be in the form of a batch or other executable file. By virtue of the command line programs being generic, such line programs have one or more variables or other input parameters which require specific input data from the administrator. Such specific information may include general information, such as the identity of the platform where the command line program is to be sent, to specific information, such as the personal information of a new user. Considering that the host system 112 is designed such that the platforms are independent, the administrator must not only log into the specific platform where s/he wants to implement the instruction, but must also retrieve the generic command line program associated with the instruction, apply the required specific input data and instruct that platform to execute the command line program.

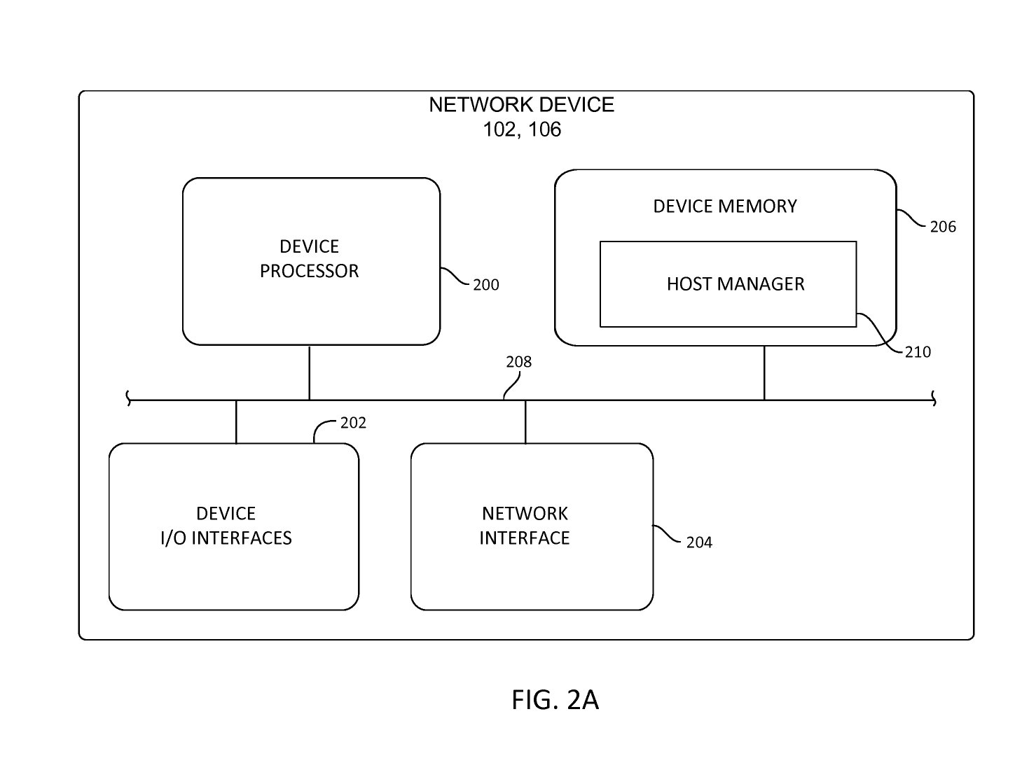

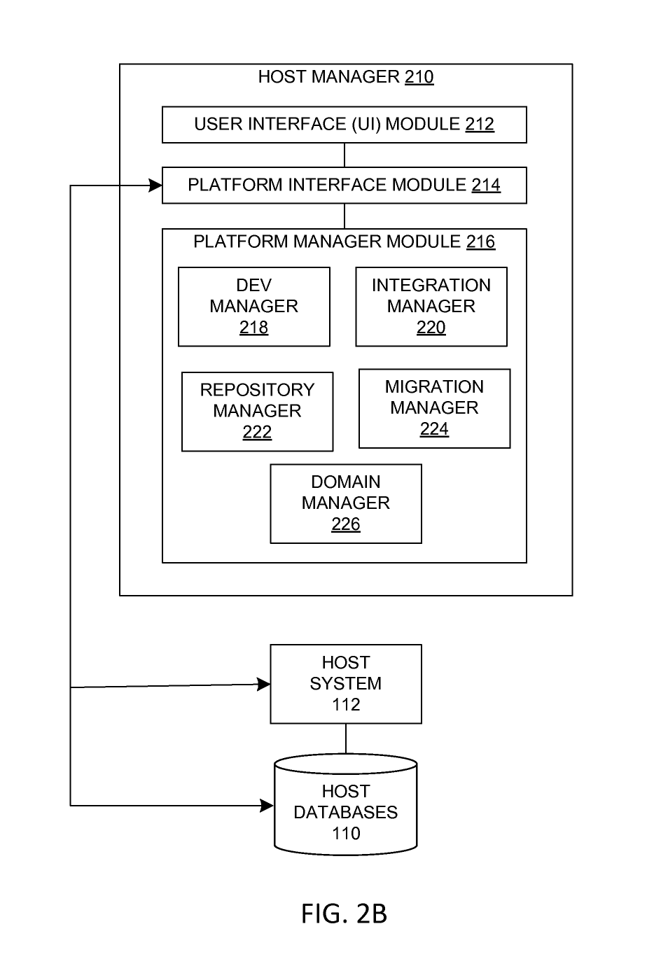

FIG. 2A illustrates a block diagram of a network device configured to execute a host system manager module in accordance with an aspect of the present disclosure. With regard to FIG. 2A, the network device may be one or more servers 102 and/or one or more client devices 106. Accordingly, in an aspect, the host manager module 210 may be locally stored and executed in a memory on a client device 106. In another aspect, the host manager module 210 resides in a memory of a server device 102, wherein the host manager module 210 is executed and run remotely or locally, in association with the one or more servers 102, by the administrator. It is also contemplated that the host manager module 210 may reside in the ‘cloud’ and thus be a software on demand solution.

The network device 102, 106 includes one or more device processors 200, one or more device I/O interfaces 202, one or more network interfaces 204 and one or more device memories or storage device 206, all of which are coupled together by one or more buses 208. It should be noted that the network device 102, 106 could include other types and numbers of components.

Device processor 200 comprises one or more microprocessors configured to execute computer/machine readable and executable instructions stored in the respective local or remote device memory 206. Such instructions are executed by the processor 200 to perform one or more functions described below. It is understood that the processor 200 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200 is programmed or configured to execute the process in accordance with the teachings as described and illustrated herein of the novel system and method described below.

Device I/O interfaces 202 comprise one or more user input and output device interface mechanisms. The interface may include a computer keyboard, mobile device keypad, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

Network interface 204 comprises one or more mechanisms that enable the network device 102, 106 to engage in TCP/IP communications or other communications over the LAN 104 and network 108. However, it is contemplated that the network interface 204 may be constructed for use with other communication protocols and types of networks. Network interface 204 is sometimes referred to as a transceiver, transceiving device, or network interface card (NIC), which transmits and receives network data packets over one or more networks, such as LAN 104 and network 108. In particular to the present disclosure, the network interface 204 operates in conjunction with the host manager 210 to allow data communications between the user administrator and the host manager 210 (via the central user interface), but also allow data communications between the host manager 210 and a plurality of host system platforms.

In an example where the client device 106 and/or server 102 includes more than one device processor 200 (or a processor 200 has more than one core), each processor 200 (and/or core) may use the same single network interface 204 or a plurality of network interfaces 204 to communicate with other network devices. Further, the network interface 204 may include one or more physical ports, such as Ethernet ports, to couple its respective device with other network devices in the system 100. Moreover, the network interface 204 may include certain physical ports dedicated to receiving and/or transmitting certain types of network data, such as device management related data for configuring the respective device, and the like.

Bus 208 may comprise one or more internal device component communication buses, links, bridges and supporting components, such as bus controllers and/or arbiters. The bus enable the various components of the network device such as the processor 200, device I/O interfaces 202, network interface 204, and device memory 206, to communicate with one another. However, it is contemplated that the bus may enable one or more components of its respective network device to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the network device which houses the bus.

Device memory 206 of the network device 102, 106 comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200. Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As shown in FIG. 2A, the host manager module 210 is shown within the memory 206 and comprises computer readable/machine executable instructions. It is contemplated that the host manager module 210 may alternatively be housed in another memory external to the memory 206. Such stored instructions allow the processor 200 to perform actions described in association with interfacing with the host system 112 and its various platforms and databases. As mentioned above, the host manager module 210 may reside in localized storage in the server 102 and/or client device 106, in an aspect. It is also contemplated that portions of the host manager module 210 may be distributed in more than one network device in a cloud computing environment, in another aspect.

FIG. 2B illustrates a block diagram of the components of an example host manager in accordance with an aspect of the present disclosure. As shown in FIG. 2B, the host manager module 210 includes a centralized user interface module 212, a platform command module 214, and a platform interface module 216. It should be noted that the host manager 210 and its illustrated modules/managers 212-222 are exemplary and are thus not considered to be limiting. Accordingly, additional, fewer and/or different modules/managers are contemplated.

In general, the host manager 210 is a software implementation which interfaces and operates with a decentralized host system 112 provided by another software developer. In particular, the host manager 210 is configured to provide a centralized platform which allows an administrator to access a plurality of the host system's 112 independent platform solutions from a single, centralized user interface. Additionally, the host manager 210 utilizes a plurality of configurable platform manager modules 216 which are designed to provide generic platform executable instructions for an identified platform of the host system 112. The host manager 214 also utilizes a platform interface module 214 which utilizes input data provided by the administrator in association with the general command instruction to generate a finalized instruction that is sent to the appropriate platform of the host system 112 and/or its dedicated database(s).

In an aspect, the user interface module 212 is configured to display a single, centralized web-based or non web-based user interface configured to allow an administrator to manage a plurality of independent, decentralized software platforms of the host system 112. As will be discussed in more detail below, the user interface module 212 works in conjunction with the platform interface module 214 and the various host platform managers 218-226 (referred to as “platform managers”) of the platform manager module 216 to enable centralized access and management of the various software platforms of the host system 112.

The host interface module 214 interfaces with the various host platforms of the host system 112 and transmits finalized executable instructions from the host manager 210 to the identified host platform for execution and/or a dedicated host platform database for storage. In an aspect, the host interface module 214 accesses an identified host platform and/or its dedicated database(s) to retrieve requested data, confirm policy information, confirm administrator credential information and the like.

As shown in FIG. 2B, the platform manager module 216 manages the various command line programs and other executable commands that are general to the host system 112 and/or specific to a particular host platform. In the example in FIG. 2B, the platform manager module 216 includes a plurality of platform managers, such as a development (dev) manager 218, an integration manager 220, a repository manager 222, a migration manager 224, and a domain manager 226. In illustrated example, the platform managers of the host platform manager 216 correspond to the available host platforms of the host system 112.

In an aspect, each platform manager in the platform manager module 216 manages a library of generic command line programs that may be specific to the host platform which corresponds to that platform manager. For example aspect, the integration manager 220 may contain a library of generic command line programs that are specific to the integration host platform 116A of the host system 112 (FIG. 1B). Similarly, the migration manager 224 may contain a library of generic command line programs that are specific to the migration host platform 120A of the host system 112 (FIG. 1B). In an aspect, one or more platform managers of the host manager 210 may contain a library of generic command line programs that are general and can be applied to more than one host platform access and manage the specific platforms 114-122 of the host system 112.

In an aspect, the command line programs available to the administrator (based on the administrator's credentials) are communicated to the user interface module 212, wherein the user interface module 212 displays available instructions on the user interface in accordance with the available command line programs. As mentioned above, each generic command line program may require one or more pieces of input data (e.g. variables, environments, parameter values) from the administrator before the command line program can be sent to the corresponding host platform for execution. The user interface module 212 thus displays the requisite input data on the user interface in conformance with the selected command line program that the administrator wants to send to the host platform. Once the user inputs the requisite input data, via the user interface, the specified platform manager utilizes the user inputted data along with the generic command line program to generate a script that is representative of a finalized instruction message. The finalized instruction message is thereafter sent by the host interface module 214 to the corresponding host platform for execution and/or storage.

Referring to the command line programs that are handled by the various platform managers, some command line programs may be generic and thus applicable to more than one host platform. For instance, the user interface module 210 may display menu items which allow the administrator to add one or more users (individually or in a group) and delete one or more users (individually or in a group). Accordingly, the administrator can add/delete users in different host platforms via the host manager 210 without having to repeatedly log in those specific host platforms.

In an example aspect, the repository manager 222 may be configured to allow the administrator to perform a backup of an identified host platform via the user interface. Additionally/alternatively, the repository manager 222 may be configured to allow the administrator to create, delete and/or update one or more relational connections in any identified host platform via the host manager's 210 user interface. The user interface module 212 will display the requisite input data (e.g. user name, connection string, database name, host platform where relational connection is to occur, server name). The host interface module 214 can access the identified host platform's database and retrieve stored information from the database, wherein the user interface module 212 automatically populates one or more input data fields.

In an aspect, the host manager 210 may be configured to allow the administrator to import new and/or modified customized command line programs, which are part of the host system's 112 library of generic command line programs, wherein such new/modified command line programs may implement new features that are handled by the various appropriate managers in the platform interface module 216 and executed by the appropriate platform in the host system 112.

In an aspect, the host manager 210 may utilize a user emulation tool which is configured to locally store one or more user's profile data in a memory 206 or other remote storage, wherein the host manager 210 can retrieve the user's profile data from the memory 206 and automatically populate that user's profile data for insertion to a user group that is to be applied to a particular host platform and stored in its dedicated database. For example, the administrator who is adding a new user to a user group may have to manually retrieve policy and permissions information for other users in the user group. The host manager 210, by utilizing the emulation tool, is able to retrieve the policy and permissions information for other users in the identified user from the host platform's dedicated database and automatically populate that information for the new user. In an aspect, the host manager 210 is able to retrieve the needed information from the local database so that the information can be populated among a plurality of identified host platforms.

In an aspect, the repository manager 222 may utilize a connection list command line program that allows the administrator to view data of all past or current connections made to a repository in an identified host platform. For example, the host manager 210 may utilizes a connection module that monitors the number of user and/or relational connections made to a particular host platform's repository in real time or over a set amount of time. This information is presented to the user via the user interface and is advantageous as the administrator is able to determine whether the total connections to a particular repository is approaching, has reached or has exceeded a set threshold limit. In the example, if the host manager 210 displays that a particular repository has reached its maximum number of connections, the host manager 210 can provide information identifying any unused/idle connections and/or stranded users in established connections to the repository. The host manager 210 may be configured to allow the administrator, once s/he has identified the connections that have stranded users and/or are idle, to kill or other terminate those connections via the user interface.

In an aspect, the integration manager 220 may be configured to implement a command line program which allows the host manager 210 to display, via the user interface, all the connection IDs and their associated objects for established connections to the repository. For example, for a workflow to run on the host platform, an ‘execute lock’ is acquired for the workflow, wherein the lock is released after the workflow is finished running. In the event that the ‘execute lock’ is not acquired or not released, the workflow may fail to run. Accordingly, the repository manager 222 is able to access the repository host platform and perform a query which identifies all the established connections along with one or more desired objects (e.g. locks). The host manager 210 allows the administrator to run the query via the user interface module 212 to find the desired connection ID and the lock, wherein the connection can be terminated by the administrator.

In an aspect, the migration manager 224 may be configured to implement a command line program which allows the administrator to migrate data from one host platform to one or more other host platforms. In a particular example aspect, the host manager 210, via the migration and repository managers, allows a defined deployment group to be migrated from a selected source host platform to one or more selected destination host platforms. Additionally/alternatively, one or more deployment groups may be deleted by the administrator via the host manager 210 user interface. The host manager 210 may also be configured to allow the administrator to copy parameter files from a source host platform to one or more destination host platforms via the user interface.

In an aspect, the domain manager 226 may be configured to implement a command line program which allows the administrator to perform domain database backup functions to one or more backup storage locations. In an aspect, the domain manager 226 allows the administrator to perform domain refresh functions, wherein temporary and cached files are deleted from the host platform. In an aspect, the host manager 210 is configured to perform health and diagnostic processes on one or more servers handling an identified host platform. In an aspect, the host manager 210 is configured to allow the administrator to take one or more servers offline, bring on-line, reboot and the like.

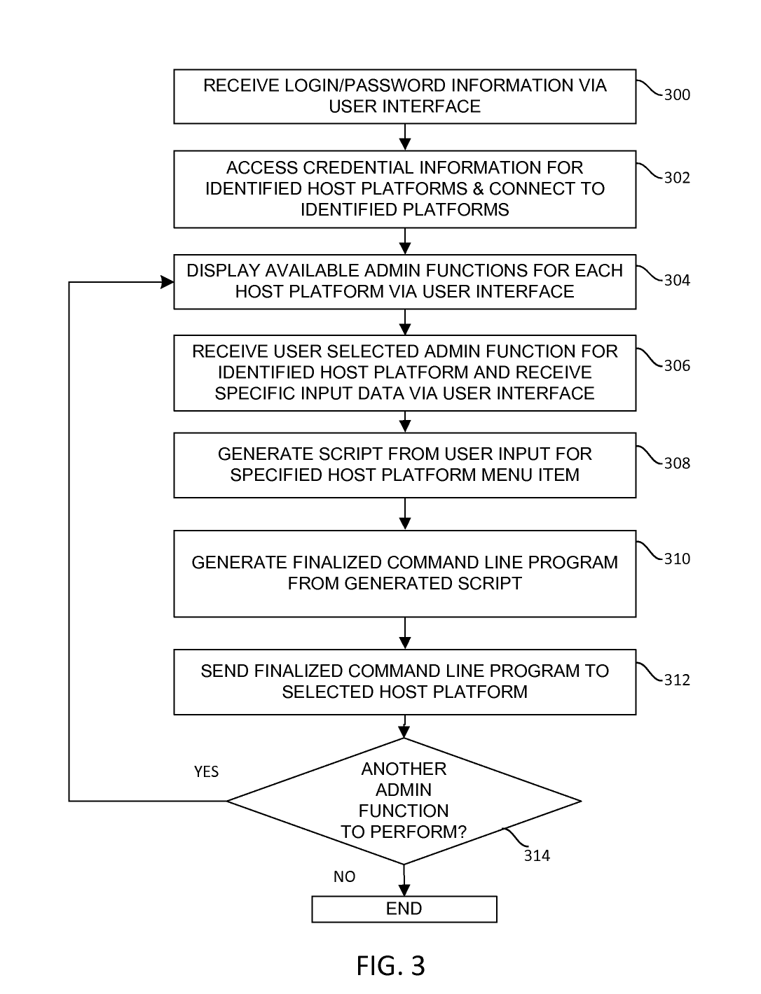

FIG. 3 illustrates a flow chart describing the host manager's capabilities in accordance with an aspect of the present disclosure. As shown in FIG. 3, the user interface module 212 displays a Web or non-Web based user interface to the administrator, wherein the user interface is configured to display log-in and password fields. As shown in Block 300, the host manager 210 receives login and password information from the administrator via the user interface (Block 300).

Once the administrator inserts his/her login/password information, the host manager 210 accesses a local database or all the databases for the available host platforms to retrieve credential information for the administrator with respect to all host platforms to which the administrator has access (Block 302). In addition, with respect to Block 302, the host manager 210, via the platform interface module 214, also connects to the identified host platforms that are available to the administrator based on his/her credentials.

The host manager 210 also retrieves all available administrator functions from its platform managers based on his/her credentials, wherein the user interface module 212 populates the user interface with all available administrator functions, as menu items, for each available host platform (Block 304).

The host manager 210 thereafter receives, via the user interface, a selection from the administrator to perform a specific administrative function or activity on one or more identified host platforms (Block 306). As mentioned above, the corresponding platform manager of the host manager 210 will provide a script of a generic command line program associated with the selected administrative function, wherein specific input data is needed (from the user and/or a database) before the instruction can be finalized and sent to the host system 112.

Accordingly, with respect to Block 306, the host manager 210 receives input data, such as input variables, environments, and/or parameter data, from the administrator via the user interface, wherein input data is specific to the selected administrative function that is to be executed on the identified host platform (Block 306). Additionally/alternatively, input data may be retrieved from one or more databases, wherein some (or no) input data is received from the administrator.

Once the required specific input data for the instruction is received, the host manager 210 applies the input data to the generic command line program for the associated administrative function to be performed (Block 308). For instance, if the command line program requires that a specific variable be in a specific form, the generated script will convert the input data into the specified form when incorporating the script into the command line program. The host manager 210 thereafter generates a finalized command line program including the needed input data for the associated administrative function (Block 310).

The platform interface module 214 thereafter sends the finalized command line program to the user identified host platform and/or its dedicated database(s) (Block 312). The identified host platform, upon receiving the finalized command line program from the host manager 210, executes the finalized command line program. In an aspect, any changes in the host platform as a result of the administrator's instruction can be accessed by the host manager 210, wherein updated information (if applicable) can be viewed via the host manager's user interface.

As shown in FIG. 3, the host manager 210 thereafter allows the administrator to perform another administrative function on the same and/or different host platform (Block 314). If the administrator would like to perform another administrative function, the process goes back to Block 304. Otherwise, the process ends (End Block).

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of providing a centralized host manager module configured to manage a software-based host system having a plurality of independent host platforms, the method comprising:
displaying a user interface of the host manager module on a network device, wherein the user interface provides one or more administrative tools for performing corresponding administrative functions on the plurality of host platforms;
receiving, at the host manager module, a first selection from the user via the user interface, the first selection to perform a first administrative function on a first host platform, wherein the first administrative function is associated with a first generic command line program;
receiving, at the host manager module, first input data from the user via the user interface, the first input data in conformance with the first generic command line program;
generating a first finalized command line program utilizing the first generic command line program and the first input data; and
sending the first finalized command line program from the host manager module to the first host platform, wherein the first finalized command line program is configured to cause the first host platform to execute the first finalized command line program.

2. The method of claim 1, further comprising:
receiving, at the host manager module, a second selection from the user via the user interface, the second selection to perform a second administrative function on a second host platform, wherein the second administrative function is associated with a second generic command line program;
receiving, at the host manager module, second input data from the user via the user interface, the second input data in conformance with the second generic command line program;
generating a second finalized command line program utilizing the second generic command line program and the second input data; and
sending the second finalized command line program from the host manager module to the second host platform, wherein the second finalized command line program is configured to cause the second host platform to execute the second finalized command line program.

3. The method of claim 1, wherein the first finalized command line program is configured to cause at least a portion of the input data to be stored in a database of the first host platform.

4. The method of claim 1, further comprising:
storing the first input data for the first administrative function in a storage;
receiving, at the host manager module, a second selection from the user via the user interface to perform a second administrative function, wherein the second administrative function is associated with a second generic command line program;
retrieving at least a portion of the first input data from the storage and applying the at least the portion of the first input data to the second generic command line; and
generating a second finalized command line program utilizing the second generic command line program and the at least the portion of the first input data.

5. The method of claim 1, further comprising receiving login and password information from the user via the user interface;
retrieving credential information for the user using the received login and password information;
identifying available administrative functions for each available host platform based on the credential information; and
displaying the available administrative functions for each available host platform via the user interface.

6. The method of claim 1, wherein the first administrative function is associated with managing a relational connection in one or more host platforms.

7. A processor readable medium having stored thereon instructions for providing a centralized host manager module configured to manage a software-based host system having a plurality of independent host platforms, the medium comprising processor executable code which, when executed by at least one processor, causes the processor to:
display a user interface, wherein the user interface provides one or more administrative tools for performing corresponding administrative functions on the plurality of host platforms;
receive a first selection from the user via the user interface, the first selection to perform a first administrative function on a first host platform, wherein the first administrative function is associated with a first generic command line program;
receive first input data from the user via the user interface, the first input data in conformance with the first generic command line program;
generate a first finalized command line program utilizing the first generic command line program and the first input data; and
send the first finalized command line program from the host manager module to the first host platform, wherein the first finalized command line program is configured to cause the first host platform to execute the first finalized command line program.

8. The processor medium of claim 7, wherein the medium causes the processor to further:
receive a second selection from the user via the user interface, the second selection to perform a second administrative function on a second host platform, wherein the second administrative function is associated with a second generic command line program;
receive second input data from the user via the user interface, the second input data in conformance with the second generic command line program;
generate a second finalized command line program utilizing the second generic command line program and the second input data; and
send the second finalized command line program from the host manager module to the second host platform, wherein the second finalized command line program is configured to cause the second host platform to execute the second finalized command line program.

9. The processor medium of claim 7, wherein the first finalized command line program is configured to cause at least a portion of the input data to be stored in a database of the first host platform.

10. The processor medium of claim 7, wherein the medium causes the processor to further:
store the first input data for the first administrative function in a storage;
receive a second selection from the user via the user interface to perform a second administrative function, wherein the second administrative function is associated with a second generic command line program;
retrieve at least a portion of the first input data from the storage and applying the at least the portion of the first input data to the second generic command line; and
generate a second finalized command line program utilizing the second generic command line program and the at least the portion of the first input data.

11. The processor medium of claim 7, wherein the medium causes the processor to further:
receive login and password information from the user via the user interface;
retrieve credential information for the user using the received login and password information;
identify available administrative functions for each available host platform based on the credential information; and
display the available administrative functions for each available host platform via the user interface.

12. The processor medium of claim 7, wherein the first administrative function is associated with managing a relational connection in one or more host platforms.

13. A computing device comprising:
a network interface capable of communicating with a host system having a plurality of independent host platforms;
a memory having stored thereon code embodying machine executable programmable instructions; and
a processor configured to execute the stored programming instructions in the memory, which when executed by the processor, causes the processor to:
display a user interface, wherein the user interface provides one or more administrative tools for performing corresponding administrative functions on the plurality of host platforms;
receive a first selection from the user via the user interface, the first selection to perform a first administrative function on a first host platform, wherein the first administrative function is associated with a first generic command line program;
receive first input data from the user via the user interface, the first input data in conformance with the first generic command line program;
generate a first finalized command line program utilizing the first generic command line program and the first input data; and
send the first finalized command line program from the host manager module to the first host platform, wherein the first finalized command line program is configured to cause the first host platform to execute the first finalized command line program.

14. The computing device of claim 13, wherein the processor is configured to further:
receive a second selection from the user via the user interface, the second selection to perform a second administrative function on a second host platform, wherein the second administrative function is associated with a second generic command line program;
receive second input data from the user via the user interface, the second input data in conformance with the second generic command line program;
generate a second finalized command line program utilizing the second generic command line program and the second input data; and
send the second finalized command line program from the host manager module to the second host platform, wherein the second finalized command line program is configured to cause the second host platform to execute the second finalized command line program.

15. The computing device of claim 13, wherein the first finalized command line program is configured to cause at least a portion of the input data to be stored in a database of the first host platform.

16. The computing device of claim 13, wherein the processor is configured to further:
store the first input data for the first administrative function in a storage;
receive a second selection from the user via the user interface to perform a second administrative function, wherein the second administrative function is associated with a second generic command line program;
retrieve at least a portion of the first input data from the storage and applying the at least the portion of the first input data to the second generic command line; and
generate a second finalized command line program utilizing the second generic command line program and the at least the portion of the first input data.

17. The computing device of claim 13, wherein the processor is configured to further:
receive login and password information from the user via the user interface;
retrieve credential information for the user using the received login and password information;
identify available administrative functions for each available host platform based on the credential information; and
display the available administrative functions for each available host platform via the user interface.

18. The computing device of claim 13, wherein the first administrative function is associated with managing a relational connection in one or more host platforms.
